(19) United States
(12) Patent Application Publication
(10) Pub. No.: US 2026/0031716 A1
(43) Pub. Date: Jan. 29, 2026

(54) SOFT START CIRCUIT, SOFT START METHOD AND POWER CONVERSION SYSTEM

(71) Applicant: Silergy Semiconductor Technology (Hangzhou) LTD, Hangzhou (CN)

(72) Inventors: Yunyu Zhao, Hangzhou (CN); Gao Fan, Hangzhou (CN); Jinshuai Wang, Hangzhou (CN); Qiukai Huang, Hangzhou (CN)

(21) Appl. No.: 19/225,095

(22) Filed: Jun. 2, 2025

(30) Foreign Application Priority Data
Jul. 26, 2024 (CN) 202411017942.0

(51) Int. Cl. H02M 1/36; H02M 3/00

(52) U.S. Cl. CPC H02M 1/36; H02M 3/01

(57) ABSTRACT

A soft-start circuit for soft-starting a main power circuit, the main power circuit being configured to receive an input voltage and to generate an output voltage, the soft-start circuit can include: an auxiliary power supply circuit configured to receive the input voltage, and to generate a first voltage; where the auxiliary power supply circuit is configured to supply power to a control circuit of the main power circuit based on the first voltage; and where during a startup phase of the main power circuit, the auxiliary power supply circuit is configured to charge an energy storage capacitor of the main power circuit based on the first voltage.

### RELATED APPLICATIONS

This application claims the benefit of Chinese Patent Application No. 202411017942.0, filed on Jul. 26, 2024, which is incorporated herein by reference in its entirety.

### FIELD OF THE INVENTION

The present invention generally relates to the field of power electronics, and more particularly to soft-start circuits, soft-start methods, and power conversion systems.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of a first example power conversion system, in accordance with embodiments of the present invention.

FIG. 2 is a schematic block diagram of an example LLC resonant topology as the main power circuit, in accordance with embodiments of the present invention.

FIG. 3 is a schematic block diagram of a first example soft-start circuit, in accordance with embodiments of the present invention.

FIG. 4 is a schematic block diagram of a second example soft-start circuit, in accordance with embodiments of the present invention.

FIG. 5 is a schematic block diagram of a second example power conversion system, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

In power converter solutions, a main power circuit can be used to drive a load. Without a soft-start circuit, the output voltage of the main power circuit is typically 0V at the moment of startup, which can cause the inductor current of the main power circuit to exceed its rated value and potentially damage power devices. Therefore, a soft-start circuit may be utilized to soft-start the main power circuit. In some approaches, the soft-start can be achieved through control methods, such as high-frequency startup, phase-shift startup, or variable-duty-cycle startup. However, such control-based methods may be overly complex, difficult to implement, and may also reduce circuit reliability.

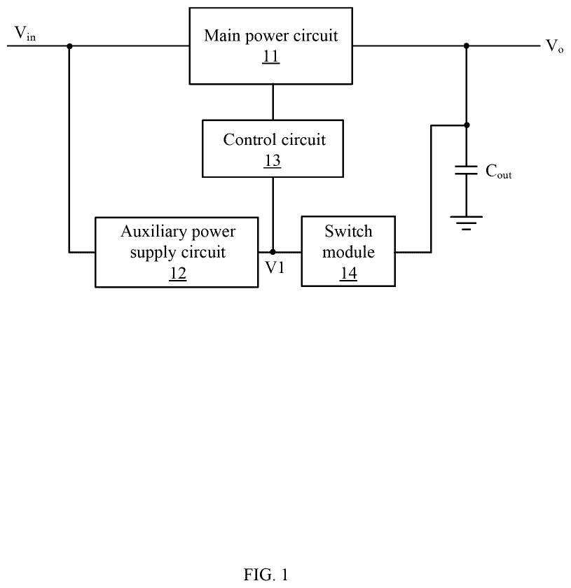

Referring now to FIG. 1 shows a schematic block diagram of a first example power conversion system, in accordance with embodiments of the present invention. In this particular example, the power conversion system can include main power circuit 11, control circuit 13, and a soft-start circuit. Main power circuit 11 may receive input voltage Vᵢₙ, and can generate an output voltage Vₒ to drive a load. Control circuit 13 can control and/or drive main power circuit 11. Optionally, control circuit 13 may also control the soft-start circuit. In another case, another control module may be used to control the soft-start circuit. The soft-start circuit can soft-start main power circuit 11 and may include auxiliary power supply circuit 12. Auxiliary power supply circuit 12 can include a power stage circuit, and may supply power to control circuit 13 continuously after system power-on. During a startup phase of main power circuit 11, auxiliary power supply circuit 12 can charge an energy storage capacitor of main power circuit 11. The power stage circuit may be any suitable converter topology (e.g., buck circuit, boost circuit, buck-boost circuit, etc.).

As shown in FIG. 1, an output terminal of auxiliary power supply circuit 12 may generate voltage V1, which can supply power to control circuit 13. During the startup phase of main power circuit 11, voltage V1 can also charge output capacitor Cₒᵤₜ at main power circuit 11. Output capacitor Cₒᵤₜ can connect to the output terminal of main power circuit 11 to filter output voltage Vₒ, and may be configured as the energy storage capacitor.

The soft-start circuit can include switch module 14 coupled between the output terminal of auxiliary power supply circuit 12 and output capacitor Cₒᵤₜ. During the startup phase of main power circuit 11, switch module 14 can be turned on, thus allowing voltage V1 to charge output capacitor Cₒᵤₜ of main power circuit 11 by reusing the power stage circuit of the auxiliary power supply circuit. It should be noted that voltage V1 generated by auxiliary power supply circuit 12 may also supply power to other circuits of main power circuit 11. Additionally, the startup phase in particular embodiments may refer to the phase after the power conversion system is powered on, but before the main power circuit operates normally.

During the startup phase, the power stage circuit can charge the energy storage capacitor. In one example, when the voltage across the energy storage capacitor reaches or exceeds preset voltage Vₛₑₜ₁, the power stage circuit may stop charging the energy storage capacitor, and then control circuit 13 can control main power circuit 11 to begin operation. In another example, when the voltage across the energy storage capacitor reaches or exceeds preset voltage Vₛₑₜ₁, control circuit 13 can control main power circuit 11 to begin operation, and then the power stage circuit may stop charging the energy storage capacitor. In yet another example, when the voltage across the energy storage capacitor reaches or exceeds preset voltage Vₛₑₜ₁, the power stage circuit can stop charging the energy storage capacitor, and simultaneously control circuit 13 can control main power circuit 11 to begin operation.

For example, when the soft-start circuit also includes switch module 14 coupled between the auxiliary power supply circuit and the energy storage capacitor, during the startup phase of main power circuit 11, switch module 14 may be enabled to allow voltage V1 to charge the energy storage capacitor. After main power circuit 11 begins operation, switch module 14 can be turned off, switch module 14 may be turned off before main power circuit 11 begins normal operation, or switch module 14 may be turned off simultaneously with main power circuit 11 beginning normal operation. This can ensure that the energy storage capacitor is charged during the startup phase without affecting the auxiliary power supply circuit to supply power to control circuit 13, and that auxiliary power supply circuit 12 remains unaffected during normal operation of main power circuit 11.

In particular embodiments, the input voltage of auxiliary power supply circuit 12 is input voltage Vᵢₙ, which can be the same as that of the main power circuit. In other examples, auxiliary power supply circuit 12 may have a different input voltage from the main power circuit. In one example, switch module 14 may include a first power switch coupled between the auxiliary power supply circuit and the energy storage capacitor. During the startup phase of main power circuit 11, the first power switch can be controlled to turn on, allowing voltage V1 to charge the energy storage capacitor.

In another example, switch module 14 may include a diode coupled between the auxiliary power supply circuit and the energy storage capacitor, with the anode of the diode connected to the output terminal of the auxiliary power supply circuit and the cathode connected to the energy storage capacitor. During the startup phase of main power circuit 11, since the output voltage of the auxiliary power supply circuit is higher than the voltage across the energy storage capacitor, the diode can be forward-biased, thus allowing voltage V1 to charge the energy storage capacitor. When the voltage across the energy storage capacitor reaches preset value Vₛₑₜ₁, main power circuit 11 can begin normal operation, and the output voltage of main power circuit 11 (e.g., the voltage across the energy storage capacitor) may exceed the output voltage of the auxiliary power supply circuit, thus causing the diode to turn off and disconnect the output terminal of the auxiliary power supply circuit from the energy storage capacitor. Due to the unidirectional conduction characteristic of the diode, the control process can be simplified. In other examples, switch module 12 may be a switch circuit including other suitable switching devices.

When main power circuit 11 is a resonant converter, in scenarios requiring soft-start, some approaches may achieve soft-start through complex control methods, such as high-frequency startup, phase-shift startup, or variable-duty-cycle startup. If the soft-start is achieved through such a control method, the main power circuit may need to establish a DC output by increasing the switching frequency or by adjusting the duty cycle before main power circuit 11 can operate stably. Such control-based soft-start methods may impose higher requirements on controller precision, and inevitably can introduce significant current stress during startup. Therefore, particular embodiments may offer significant advantages when the main power circuit is a resonant converter.

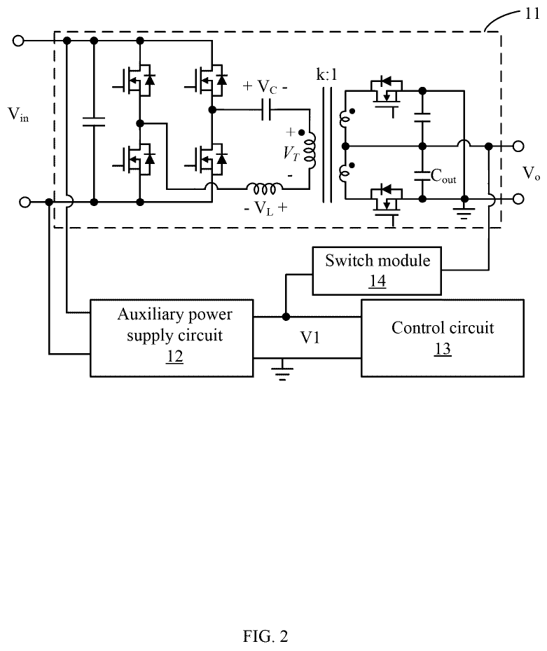

Referring now to FIG. 2 shows a schematic diagram of an example LLC resonant topology as the main power circuit, in accordance with embodiments of the present invention. In this particular example, main power circuit 11 is shown as an LLC resonant topology, where output capacitor Cₒᵤₜ of main power circuit 11 is configured as the energy storage capacitor. When main power circuit 11 starts up, if no pre-charging is performed, output voltage Vₒ of main power circuit 11 is 0V, transformer voltage V_{T} can be equal to zero, V_{T}=k*Vₒ=0V, and resonant capacitor voltage V_{C} of the resonant capacitor may be equal to zero, V_{C}=0V. Thus, without pre-charging, inductor voltage V_{L} of the inductor can be equal to input voltage Vᵢₙ, which may result in a relatively large inductor current.

Through the pre-charging process of particular embodiments, output voltage Vₒ of main power circuit 11 can be raised to preset voltage Vₛₑₜ₁, thus reducing the inductor voltage to decrease to voltage V_{L}′, V_{L}′=Vᵢₙ−k*Vₛₑₜ₁, where k is the turns ratio of the transformer (primary to secondary). It can be seen that V_{L}′<V_{L}. Without pre-charging, the inductor current may exceed its rated value, thus potentially damaging the inductor or switching devices. As such, pre-charging output capacitor Cₒᵤₜ may significantly reduce voltage V_{L} across the resonant inductor, also reduce the inductor current stress during startup of main power circuit 11, and allow for a larger initial pulse width for soft-start. As compared to the control-based methods for resonant converters, particular embodiments may reduce control difficulty, lower requirements for controller precision, and improve circuit reliability.

In the example of FIG. 2, the input voltage range of the main power circuit can be from Vₐ to V_{b}, with a fixed voltage conversion ratio of k:1. The output voltage range of main power circuit 11 during normal operation can be from Vₒ=Vₐ/k to Vₒ=V_{b}/k. The output voltage of auxiliary power supply circuit 12 is voltage V1, which may supply power to control circuit 13 and is also can connect to output capacitor Cₒᵤₜ of main power circuit 11 through switch module 14. After input voltage Vᵢₙ is applied, auxiliary power supply circuit 12 may operate first. As voltage V1 of the auxiliary power supply circuit is established, switch module 14 can turns on, thus allowing auxiliary power supply circuit 12 to charge output capacitor Cₒᵤₜ. If the conduction voltage drop of switch module 14 is V_{D}, output voltage Vₒ may satisfy Vₒ=V1−V_{D}, which may be referred to as preset voltage Vₛₑₜ₁, whereby Vₛₑₜ₁=V1−V_{D}. In this example, when control circuit 13 detects that output voltage Vₒ reaches preset voltage Vₛₑₜ₁, it can control main power circuit 11 to begin normal operation. During this process, depending on the input voltage, output voltage Vₒ can be raised to a voltage in the range of Vₐ/k to V_{b}/k. Since Vₐ/k>Vₛₑₜ₁, switch module 14 may turn off, thus disconnecting output voltage Vₒ from the output terminal of auxiliary power supply circuit 12 and ensuring that the auxiliary power supply circuit is unaffected during normal operation of the main power circuit. In another example, when control circuit 13 detects that output voltage Vₒ reaches preset voltage Vₛₑₜ₁, switch module 14 can turn off, and then or simultaneously main power circuit 11 may be controlled to begin normal operation.

It should be noted that FIG. 2 uses an LLC resonant converter as an example, but in other examples, the main power circuit may be an LC resonant circuit. Besides resonant converters, particular embodiments may also be applied to switched-capacitor circuits, phase-shifted full-bridge circuits, dual-active-bridge circuits, or even simple converters like buck or boost converters, as just a few examples.

The above examples assume that the output voltage of auxiliary power supply circuit 12 matches the voltage across the energy storage capacitor during normal operation of main power circuit 11 and the operating voltage of control circuit 13. In this case, the output of auxiliary power supply circuit 12 may directly charge the energy storage capacitor without voltage or power conversion, and auxiliary power supply circuit 12 can also directly supply power to the control circuit without voltage or power conversion. When the output voltage of auxiliary power supply circuit 12 does not match the output voltage of main power circuit 11 during normal operation or the operating voltage of control circuit 13, the power stage circuit can include a first inductor, and a second inductor coupled to the first inductor. By adjusting the coupling between the first and second inductors, the voltage across the second inductor can be tailored to match the output voltage of main power circuit 11 during normal operation or the operating voltage of control circuit 13.

In this case, the auxiliary power supply solution transitions from a single-output converter to a dual-output solution, where the first output supplies power to control circuit 13 of main power circuit 11, and the second output pre-charges the energy storage capacitor. Optionally, the first and second inductors may form a transformer or coupled inductors. The soft-start circuit may further include a rectifier circuit coupled to the second inductor to rectify the voltage across the second inductor, and to generate voltage V2 for charging the energy storage capacitor or supplying power to control circuit 13.

In one embodiment, the resonant capacitor of main power circuit 11 can be configured as the energy storage capacitor. As voltage V1 of the auxiliary power supply circuit is established, auxiliary power supply circuit 12 can charge the resonant capacitor. When control circuit 13 detects that the resonant capacitor voltage V_{C} of the resonant capacitor reaches preset voltage Vₛₑₜ₁, main power circuit 11 may be controlled to begin normal operation.

In one embodiment, the energy storage capacitor can be configured as the resonant capacitor and output capacitor Cₒᵤₜ of main power circuit 11. As voltage V1 of the auxiliary power supply circuit is established, auxiliary power supply circuit 12 can charge the resonant capacitor and output capacitor Cₒᵤₜ. When control circuit 13 detects that one of the resonant capacitor voltage V_{C} of the resonant capacitor and the voltage of output capacitor Cₒᵤₜ reaches preset voltage Vₛₑₜ₁, main power circuit 11 may be controlled to begin normal operation.

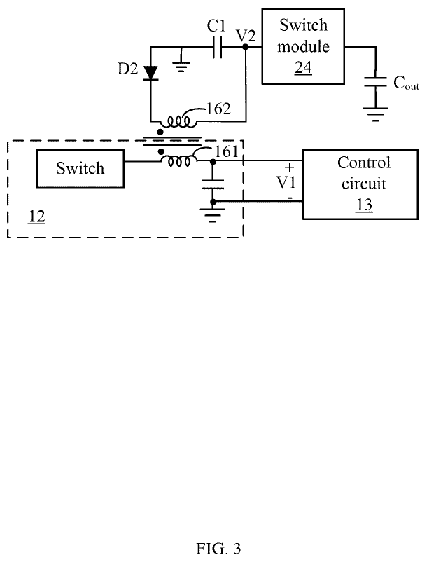

Referring now to FIG. 3, shown is a schematic block diagram of an example soft-start circuit, in accordance with embodiments of the present invention. In this particular example, the power stage circuit of the auxiliary power supply circuit can include a switching device and inductor 161. The soft-start circuit can also include inductor 162 coupled to inductor 161. When the output voltage of auxiliary power supply circuit 12 does not match the output voltage of main power circuit 11 during normal operation, especially when the output voltage of the power stage circuit is significantly lower than the output voltage of main power circuit 11, the pre-charging effect of directly charging output capacitor Cₒᵤₜ through auxiliary power supply circuit 12 can be limited. Therefore, the voltage of another output of the power stage circuit can be adjusted by modifying the coupling between inductors 161 and 162, such that the voltage generated by the power stage circuit through inductor 162 matches the output voltage of main power circuit 11 during normal operation, while the original output voltage of the power stage circuit matches the operating voltage of control circuit 13.

In the example of FIG. 3, the output terminal of the power stage circuit may generate voltage V1, which can supply power to control circuit 13. During the startup phase of main power circuit 11, output capacitor Cₒᵤₜ can be charged via inductor 162. In this example, the soft-start circuit can include a rectifier circuit coupled to inductor 162, in order to rectify the voltage across inductor 162 and generate voltage V2 for charging output capacitor Cₒᵤₜ. For example, the rectifier circuit can include capacitor C1 and diode D2 that can connect in series across inductor 162, with the anode of diode D2 connected to the reference ground. The soft-start circuit can also include switch module 24, with one end of capacitor C1 connected to the anode of diode D2 and the other end of capacitor C1 connected to switch module 24, thereby connecting switch module 24 between the rectifier circuit and output capacitor Cₒᵤₜ.

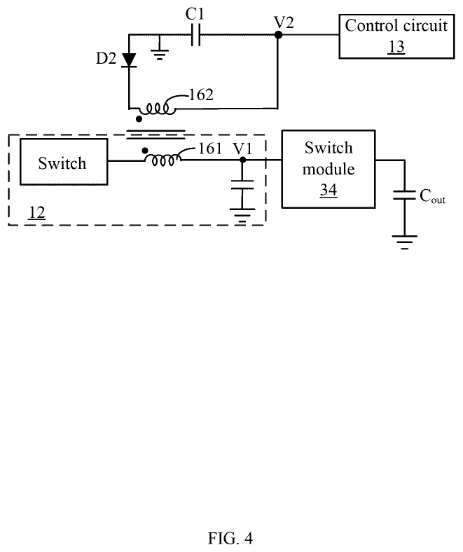

Referring now to FIG. 4, shown is a schematic block diagram of another example soft-start circuit, in accordance with embodiments of the present invention. In this particular example, the power stage circuit can include a switching device and inductor 161, and the soft-start circuit can also include inductor 162 coupled to inductor 161. When the output voltage of auxiliary power supply circuit 12 does not match the operating voltage of control circuit 13, the voltage of another output of the power stage circuit can be adjusted by modifying the turns ratio between inductors 161 and 162, such that the original output voltage of the power stage circuit matches the output voltage of main power circuit 11 during normal operation, while the voltage generated by the power stage circuit through inductor 162 matches the operating voltage of control circuit 13. The output terminal of the power stage circuit may generate voltage V1, which can charge output capacitor Cₒᵤₜ during the startup phase of main power circuit 11. Also, control circuit 13 can be supplied power via inductor 162.

The soft-start circuit can also include a rectifier circuit, which may include capacitor C1 and diode D2 connected in series across inductor 162, with the anode of diode D2 connected to the reference ground. One end of capacitor C1 can connect to the anode of diode D2, and the other end of capacitor C1 can connect to control circuit 13, thereby rectifying the voltage across inductor 162, in order to generate voltage V2 for supplying power to control circuit 13. The soft-start circuit can also include switch module 34 coupled between inductor 161 and output capacitor Cₒᵤₜ.

In the above examples, the output voltage of auxiliary power supply circuit 12 not matching the output voltage of main power circuit 11 during normal operation can indicate that the output voltage of auxiliary power supply circuit 12 differs significantly from the output voltage of main power circuit 11. Similarly, the output voltage of auxiliary power supply circuit 12 not matching the operating voltage of control circuit 13 may indicate that the output voltage of auxiliary power supply circuit 12 differs significantly from the operating voltage of control circuit 13, thus making it unsuitable for directly supplying power to control circuit 13.

In one example, during the startup phase, the load of the main power circuit can connect to the output terminal of the main power circuit or the load is enabled. When the voltage across the energy storage capacitor reaches or exceeds the first preset voltage, the power stage circuit may stop charging the energy storage capacitor, and/or the control circuit can control the main power circuit to begin operation. In another example, during the startup phase, the load of the main power circuit can be coupled to the output end of the main power circuit, or the load may be enabled. When the voltage on the energy storage capacitor is not less than the first preset voltage, the power stage circuit can stop charging the energy storage capacitor, and/or the control circuit can control the main power circuit to start operating. In another example, in the startup phase, the load of the main power circuit and the output end of the main power circuit may be disconnected, or the load may not be enabled. When the voltage on the energy storage capacitor is not less than the first reference voltage, the power stage circuit can stop charging the energy storage capacitor, and/or the control circuit can control the main power circuit to start operating. The control circuit may generate a first enabling signal to control the load to be connected to the output end of the main power circuit, or the load to be enabled.

When the energy storage capacitor is output capacitor Cₒᵤₜ of main power circuit 11, the voltage at both ends of output capacitor Cₒᵤₜ can be the output voltage of main power circuit 11. When the operating power required by the load connected to the output end of the main power circuit is relatively large, in the start-up stage, the auxiliary power supply circuit alone may not be able to output the voltage that can meet the normal operation of the load. As such, it may be more advantageous to use the first enabling signal to control the normal operation of the load or to access the main power circuit. For example, in the start-up phase of main power circuit 11, the load may not be enabled (e.g., the load can operate in standby mode). In this case, when the voltage on the energy storage capacitor is not less than the first preset voltage, main power circuit 11 can start operating and/or the power stage circuit may stop charging the energy storage capacitor. Control circuit 13 can send the first enabling signal to the load, such that the load is enabled and the load operates in normal operating mode. In another example, during the start-up phase, the load of main power circuit 11 and the output of main power circuit 11 can be disconnected. In this case, when the voltage on the energy storage capacitor is not less than the first preset voltage, main power circuit 11 may start operating and/or the power stage circuit may stop operating on the energy storage capacitor.

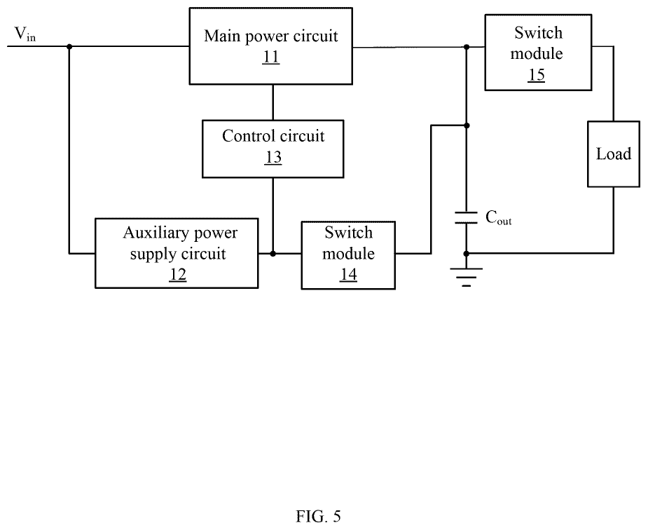

Referring now to FIG. 5, shown is a schematic block diagram of a second example power conversion system, in accordance with embodiments of the present invention. In this particular example, switching module 15 can be coupled between the output and load of main power circuit 11, and switching module 15 may be turned off during the start-up phase of main power circuit 11, such that the load of main power circuit 11 and the output of main power circuit 11 are disconnected. When main power circuit 11 starts operating and/or the power stage circuit stops charging the energy storage capacitor, switching module 15 can be turned on, such that the load may connect to the output of main power circuit 11. For example, switch module 15 can be a switch device, such as a relay or transistor.

Switching module 15 can be coupled between the output and load of main power circuit 11, switching module 15 can be coupled between the output end of the main power circuit and the load, and switching module 15 can also be coupled between the first end of the output capacitor and the output of the main power circuit. The output of the main power circuit can be a port connected to the external load, and the second end of the energy storage capacitor can connect to the reference ground. In addition, FIG. 5 shows the soft-start circuit of FIG. 1. In the corresponding examples of FIGS. 3 and 4, switching module 15 can also be arranged between the output capacitor and the load of the main power circuit.

In the examples of FIGS. 1-5, output capacitor Cₒᵤₜ of main power circuit 11 is the energy storage capacitor. In other examples, the energy storage capacitor can also be the bus capacitor, the resonant capacitor of the half-bridge LLC, and so on. When the main power circuit is a resonant circuit, the energy storage capacitor can be the resonant capacitor in the resonant circuit, and may also be the output capacitor of the resonant circuit. In particular embodiments, the resonant capacitor in the resonant circuit can be charged during the start-up phase to soft-start the resonant circuit.

In particular embodiments, the soft-start circuit can charge the energy storage capacitor in the main power circuit in the start-up stage by reusing the auxiliary power supply circuit that supplies the control circuit in the main power circuit, thereby reducing the inductance current of the main power circuit in the start-up stage. For example, the soft-start circuit of certain embodiments may realize the power supply to the control circuit of the main power circuit in the full process after power-on through the same power stage circuit in the auxiliary power supply circuit, and may realize the power supply to the energy storage capacitor in the start-up stage, such that no additional power stage circuit is needed for soft start operations. In the examples in FIGS. 2 and 3, one of the output voltages of the power stage circuit and the voltage of the second inductor coupled to the first inductor in the power stage circuit may supply power to the control circuit, and the output voltage of the power stage circuit and the voltage of the second inductor coupled to the first inductor in the power stage circuit may supply power to the energy storage capacitor in the start-up phase. In the example of FIG. 3, since the power supply to the control circuit and the charging of the energy storage capacitor in the start-up phase are not the same voltage, the output voltage of the auxiliary power supply circuit and the output voltage of the main power circuit can be substantially different.

Particular embodiments may provide soft-start circuits and methods. In the start-up stage before the main power circuit operates, the energy storage capacitor of the main power circuit can be charged by an auxiliary power supply circuit. Among them, the auxiliary power supply circuit may be utilized to supply power to the control circuit of the main power circuit, and the auxiliary power supply circuit can include a power level circuit. By reusing the auxiliary power supply circuit, particular embodiments can eliminate the need for the main power circuit to realize the pre-charging of the circuit through additional auxiliary circuits, and can also eliminate soft-start through complex control for the resonant converter, thereby reducing costs and avoiding complex soft-start control methods. Particular embodiments may multiplex the auxiliary power supply circuit, and can connect the output of the auxiliary power supply circuit with the energy storage capacitor of the main power circuit through the switching device. The internal energy storage capacitor can be charged before the main power circuit is started. When the main power circuit operates normally, the switching device can be disconnected to ensure that the main power circuit does not affect the auxiliary power supply circuit when it operates normally.

In particular embodiments, the switch module, transistor, or device can adopt various existing types of electrically controllable switches, such as metal-oxide-semiconductor field-effect transistor (MOSFET), bipolar-junction transistor (BJT), or insulated-gate bipolar transistor (IGBT), just to name a few examples.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A soft-start circuit for soft-starting a main power circuit, the main power circuit being configured to receive an input voltage and to generate an output voltage, the soft-start circuit comprising:
a) an auxiliary power supply circuit configured to receive the input voltage, and to generate a first voltage;
b) wherein the auxiliary power supply circuit is configured to supply power to a control circuit of the main power circuit based on the first voltage; and
c) wherein during a startup phase of the main power circuit, the auxiliary power supply circuit is configured to charge an energy storage capacitor of the main power circuit based on the first voltage.

2. The soft-start circuit of claim 1, further comprising:
a) a first switch module coupled between the auxiliary power supply circuit and the energy storage capacitor; and
b) wherein, during the startup phase, the first switch module is enabled to allow the first voltage to charge the energy storage capacitor through the first switch module.

3. The soft-start circuit of claim 2, wherein:
a) the first switch module comprises a first power switch coupled between the auxiliary power supply circuit and the energy storage capacitor; and
b) wherein, during the startup phase, the first power switch is turned on to allow the first voltage to charge the energy storage capacitor through the first power switch.

4. The soft-start circuit of claim 2, wherein:
a) the first switch module comprises a diode coupled between the auxiliary power supply circuit and the energy storage capacitor; and
b) during the startup phase, the diode is forward-biased to allow the first voltage to charge the energy storage capacitor through the diode.

5. The soft-start circuit of claim 1, wherein the auxiliary power supply circuit is configured to generate a second voltage that is proportional to the first voltage.

6. The soft-start circuit of claim 5, wherein the auxiliary power supply circuit comprises:
a) a power stage circuit having a first inductor, and a second inductor coupled to the first inductor;
b) a first output terminal coupled to the first inductor, and being configured to generate the first voltage;
c) a second output terminal coupled to the second inductor, and being configured to generate the second voltage;
d) wherein the first voltage is configured to supply power to the control circuit; and
e) wherein during the startup phase, and the second voltage is configured to charge the energy storage capacitor via the second inductor.

7. The soft-start circuit of claim 6, further comprising a second switch module coupled between the second output terminal and the energy storage capacitor.

8. The soft-start circuit of claim 5, wherein the auxiliary power supply circuit comprises:
a) a power stage circuit having a first inductor, and a second inductor coupled to the first inductor;
b) a first output terminal coupled to the first inductor configured to generate the first voltage;
c) a second output terminal coupled to the second inductor configured to generate the second voltage;
d) wherein the second voltage is configured to supply power to the control circuit; and
e) wherein during the startup phase, and the first voltage is configured to charge the energy storage capacitor.

9. The soft-start circuit of claim 8, further comprising a third switch module coupled between the first inductor and the energy storage capacitor.

10. The soft-start circuit of claim 1, wherein:
a) the energy storage capacitor is configured as an output capacitor coupled to an output terminal of the main power circuit; and
b) during the startup phase the auxiliary power supply circuit is configured to charge the output capacitor to increase the output voltage of the main power circuit.

11. The soft-start circuit of claim 1, wherein:
a) when the main power circuit is configured as a resonant converter, the energy storage capacitor being configured as a resonant capacitor in the resonant converter; and
b) during the startup phase the auxiliary power supply circuit is configured to charge the resonant capacitor.

12. The soft-start circuit of claim 1, wherein:
a) during the startup phase, the auxiliary power supply circuit charges the energy storage capacitor; and
b) when the control circuit detects that the voltage of the energy storage capacitor is not less than a first predetermined voltage, the main power control circuit is controlled by the control circuit to start operating.

13. The soft-start circuit of claim 1, wherein:
a) an output terminal of the main power circuit is disconnected from a load; and
b) when the voltage of the energy storage capacitor is not less than a first predetermined voltage the auxiliary power supply circuit stops charging the energy storage capacitor, and the main power circuit begins operation, the load is controlled to connect to the output terminal of the main power circuit.

14. The soft-start circuit of claim 13, wherein the auxiliary power supply circuit comprises:
a) a fourth switch module coupled between the output terminal of the main power circuit and the load; and
b) wherein, when the auxiliary power supply circuit stops charging the energy storage capacitor, and the main power circuit begins operation, the fourth switch module is controlled to turn on, thereby connecting the load to the output terminal of the main power circuit.

15. The soft-start circuit of claim 1, wherein:
a) during the startup phase, a load of the main power circuit is disabled; and
b) when the voltage across the energy storage capacitor reaches a first preset voltage, the auxiliary power supply circuit stops charging the energy storage capacitor, and the main power circuit begins operation to enable the load to operate.

16. A method of soft-starting a main power circuit, the main power circuit being configured to receive an input voltage and generate an output voltage, the method comprising:
a) receiving the input voltage, and generating a first voltage by an auxiliary power supply circuit;
b) during a startup phase of the main power circuit, charging an energy storage capacitor of the main power circuit based on the first voltage; and
c) supplying power to a control circuit of the main power circuit based on the first voltage.

17. The method of claim 16, wherein the auxiliary power supply circuit is configured to generate a second voltage that is proportional to the first voltage.

18. The method of claim 17, wherein the auxiliary power supply circuit comprises:
a) a power stage circuit having a first inductor, and a second inductor coupled to the first inductor;
b) a first output terminal coupled to the first inductor configured to generate the first voltage;
c) a second output terminal coupled to the second inductor configured to generate the second voltage;
d) wherein the first voltage is configured to supply power to the control circuit; and
e) wherein during the startup phase, and the second voltage is configured to charge the energy storage capacitor.

19. The method of claim 17, wherein the auxiliary power supply circuit comprises:
a) a power stage circuit having a first inductor, and a second inductor coupled to the first inductor;
b) a first output terminal coupled to the first inductor configured to generate the first voltage;
c) a second output terminal coupled to the second inductor configured to generate the second voltage;
d) wherein the second voltage is configured to supply power to the control circuit; and
e) wherein during the startup phase, and the first voltage is configured to charge the energy storage capacitor.

20. The method of claim 16, wherein:
a) the energy storage capacitor is configured as an output capacitor coupled to an output terminal of the main power circuit; and
b) during the startup phase, the auxiliary power supply circuit is configured to charge the output capacitor to increase the output voltage of the main power circuit.
